(19) United States
(12) Patent Application Publication
(10) Pub. No.: US 2022/0306489 A1
(43) Pub. Date: Sep. 29, 2022

(54) APPARATUS AND RELATED METHODS FOR BIOGAS CAPTURE FROM WASTEWATER

(71) Applicant: Brown and Caldwell, Walnut Creek, CA (US)

(72) Inventors: John Loyal Willis, Norcross, GA (US); Daniel Talmadge Hull, III, Atlanta, GA (US); Jose A. Jimenez, Winter Springs, FL (US); Vasuthevan Ravisangar, Marietta, GA (US)

(21) Appl. No.: 17/619,470

(22) PCT Filed: Feb. 28, 2020
(86) PCT No.: PCT/US20/20307

§ 371 Date: Dec. 15, 2021

Related U.S. Application Data
(60) Provisional application No. 62/868,453, filed on Jun. 28, 2019.

(51) Int. Cl. C02F 1/20

(52) U.S. Cl. CPC C02F 1/20; C02F 2101/101

(57) ABSTRACT

Methods for capture of biogas from a wastewater system are disclosed herein. The methods may include the step of collecting biogas within a collector chamber of a biogas collector formed at an elevated location in a wastewater system, the biogas being released from wastewater passing though the collector chamber. The methods may include the step of controlling the withdrawing of biogas from the collector chamber, and the step of capturing the biogas withdrawn from the collector chamber. The methods may include performing the step of collecting biogas within a collector chamber of a biogas collector by reducing a pressure within at least portions of the collector chamber. The methods may include the step of conveying biogas withdrawn from the collector chamber to a biogas disposer. Related apparatus for capture of biogas from a wastewater system are disclosed herein.

### TECHNICAL FIELD

This disclosure relates to wastewater treatment apparatus, and, more particularly, to apparatus for capture of biogas from wastewater flows.

### BACKGROUND ART

Wastewater, as used herein, may include sanitary sewage and industrial wastewaters derived from a variety of sources including, for example, residential, commercial and industrial sources, storm water runoff, or sanitary sewage in combination with storm water runoff. As wastewater is conveyed through various wastewater pathways and treated at a wastewater treatment plant, biological processes occur that form biogas, which includes carbonaceous gasses such as carbon dioxide CO₂ and methane CH₄, sulfur-based gasses such as hydrogen sulfide H₂S and mercaptans, and various nitrogen-based compounds such as nitrate, nitrite, nitrous oxide N₂O and ammonia NH₃. Wastewater, as used herein, may further include liquid streams or sludge recycle streams within wastewater treatment facilities.

Emissions of CH₄ from wastewater may be significant, and CH₄ may pose a fire or explosion hazard under certain circumstances. CH₄ is also a potent greenhouse gas that may have, for example, 21 to 28 times the 100-year global warming potential of CO₂. H₂S in wastewater may cause noxious odors, corrosion due to sulfuric acid formed from H₂S, and pose a toxic and potentially-lethal hazard to workers.

Anaerobic sludge digestion processes may be used for anaerobic digestion of sludge produced during treatment of bulk wastewater flows. Digested sludge from such anaerobic sludge digestion processes may be saturated or supersaturated with biogas including CH₄, CO₂, and H₂S. When digested sludge is dewatered or disposed of, these biogases may be released to the atmosphere.

Anaerobic processes may be used for primary or secondary wastewater treatment that convert settleable and soluble sewage carbon, at least in part, to biogas. Exemplary anaerobic processes include anaerobic membrane bioreactors (An-MBRs), upflow anaerobic filters (UAFs), and upflow anaerobic sludge blankets (UASBs) as well as more conventional processes such as anaerobic lagoons. Effluent from such anaerobic processes may be saturated or supersaturated with biogas particularly CH₄, and the high flow volumes result in production of large quantities of biogas that may be emitted to the atmosphere in downstream processes. Handling the resulting dissolved biogas has been identified as a serious challenge for these full-plant-flow anaerobic processes.

Currently, biogas produced from wastewater may be emitted as concentrated biogas or vented to the atmosphere as foul air. For example, under current practice, biogas may be vented to the atmosphere from vacuum relief valves positioned along force mains conveying wastewater. Various physical or chemical processes may be used to absorb or otherwise remove certain components of the biogas or biogas-component-laden foul air. Biogas may have high concentrations of CH₄ and as such, when collected, may be used as a fuel source. Biogas has been used to produce heat for process heating and/or power-generation or to fuel, at least in part, internal combustion engines or combustion turbines. Biogas may be cleaned to natural-gas quality to offset fossil natural gas demand.

Wastewater may be treated with chemicals such as chlorine, iron salts, and bases (e.g. lime, caustic soda) at selected locations to curb biological activity, chemically bind biogas components, and/or curb emission of biogas components to the atmosphere. Aerobic processes may be employed that oxidize biogas into less hazardous compounds that are then vented to the atmosphere. Such existing processes may be costly, may require purchase, storage, and use of potentially hazardous chemicals, may require significant electrical power for high-volume ventilation, necessitate ongoing operations and maintenance, and require sizable initial capital investment.

Accordingly, there is a need for improved method and related apparatus that capture and dispose of biogas produced by wastewater.

### DISCLOSURE OF THE INVENTION

These and other needs and disadvantages may be overcome by the methods and related apparatus for capture of biogas from a wastewater system disclosed herein. Additional improvements and advantages may be recognized by those of ordinary skill in the art upon study of the present disclosure.

In various aspects, the methods include the step of collecting biogas within a collector chamber of a biogas collector formed at an elevated location in a wastewater system, the biogas being released from wastewater passing through the collector chamber. The methods, in various aspects, include the step of controlling the withdrawing of biogas from the collector chamber, and the step of capturing the biogas withdrawn from the collector chamber. The methods may include performing the step of collecting biogas within a collector chamber of a biogas collector by reducing a pressure within at least portions of the collector chamber. The methods may include the step of conveying biogas withdrawn from the collector chamber to a biogas disposer. The step of withdrawing biogas from the collector chamber may be performed either intermittently or continuously, in various aspects. The methods may include the step of communicating biogas through at least portions of a biogas controller using a vacuum source, the biogas controller performing the step of controlling the withdrawing of biogas from the collector chamber, and the biogas controller comprising the vacuum source. The methods may include the step of separating biogas from water within a separator chamber of a biogas separator, the separator chamber receiving water combined with biogas withdrawn from the collector chamber.

Related biogas capture apparati are also disclosed herein. In various aspects, the biogas capture apparatus includes a biogas collector formed at an elevated location in a wastewater system, and the biogas collector defines a collector chamber that collects biogas released from wastewater passing through the collector chamber. In various aspects, the biogas capture apparatus includes a biogas controller that cooperates with the biogas collector to control withdrawal of biogas from the biogas collector. In various aspects, the biogas capture apparatus includes a biogas separator to separate water from biogas following withdrawal of the biogas from the collector chamber. In various aspects, the biogas capture apparatus includes a biogas disposer to dispose of the biogas. In certain aspects, the biogas capture apparatus includes a vacuum source that communicates biogas through at least portions of the biogas controller.

This summary is presented to provide a basic understanding of some aspects of the apparatus and methods disclosed herein as a prelude to the detailed description that follows below. Accordingly, this summary is not intended to identify key elements of the apparatus and methods disclosed herein or to delineate the scope thereof.

### BRIEF DESCRIPTION OF THE DRAWINGS

FIG. 1A illustrates by schematic diagram an exemplary implementation of a biogas capture apparatus;

FIG. 1B illustrates by schematic diagram the exemplary implementation of a biogas capture apparatus of FIG. 1A;

FIG. 2 illustrates by schematic diagram portions of the exemplary implementation of a biogas capture apparatus of FIG. 1A;

FIG. 3 illustrates by cross-sectional view portions of the exemplary implementation of a biogas capture apparatus of FIG. 1A;

FIG. 4 illustrates by cross-sectional view portions of the exemplary implementation of a biogas capture apparatus of FIG. 1A;

FIG. 5A illustrates by schematic diagram a second exemplary implementation of a biogas capture apparatus;

FIG. 5B illustrates by schematic diagram the second exemplary implementation of a biogas capture apparatus of FIG. 5A;

FIG. 6 illustrates by cross-sectional view portions of the second exemplary implementation of a biogas capture apparatus of FIG. 5A; and

FIG. 7 illustrates by process flow chart exemplary methods of operation of the exemplary biogas capture apparatus of FIG. 1A and the exemplary biogas capture apparatus of FIG. 5A.

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof. Use herein of relative terms such as generally, about, approximately, essentially, may be indicative of engineering, manufacturing, or scientific tolerances such as ±0.1%, ±1%, ±2.5%, ±5%, or other such tolerances, as would be recognized by those of ordinary skill in the art upon study of this disclosure.

### DESCRIPTION OF THE INVENTION

The present application claims priority and benefit of U.S. Provisional Patent Application No. 62/868,453 filed Jun. 28, 2019, which is hereby incorporated by reference in its entirety herein.

Methods and related apparatus for capturing biogas from water passing through a wastewater system are disclosed herein. In various aspects, the methods include the step of passing wastewater through a collector chamber of a biogas collector. The biogas collector may be located at an elevated location in the wastewater system. Pressure within the collector chamber may be reduced by elevation, a vacuum source, or combinations of elevation and vacuum source, in various aspects. The methods may include the step of withdrawing biogas from the collector chamber in a controlled manner. The methods may include the step of separating water from the biogas within a separator chamber of a biogas separator, and the step of conveying the biogas to a biogas disposer for disposal. The methods may include the step of disposing of the biogas. Thus, biogas capture may include releasing biogas from water, collecting the biogas following release of the biogas from the water, and disposing of the biogas.

In various aspects, the biogas capture apparatus includes a biogas collector that defines a collector chamber placed at an elevated location in the wastewater system. In various aspects, biogas may collect within the collector chamber by virtue of the elevation of the collector chamber with respect to the hydraulic grade. In various aspects, biogas may be released from the wastewater within the collector chamber by pressure within the collector chamber less than ambient pressure according to Henry's Law. A vacuum source communicates with the collector chamber to withdraw biogas from the collector chamber, in various aspects. In various aspects, a biogas separator that defines a biogas separator chamber communicates with the biogas collector, and water, if any, combined with the biogas may be separated from the biogas within the separator chamber. A biogas disposer communicates with the biogas separator to receive dewatered biogas from the biogas separator, in various aspects. The biogas disposer then disposes of at least portions of the biogas, by combustion, by capture, or by combinations of combustion and capture, in various aspects.

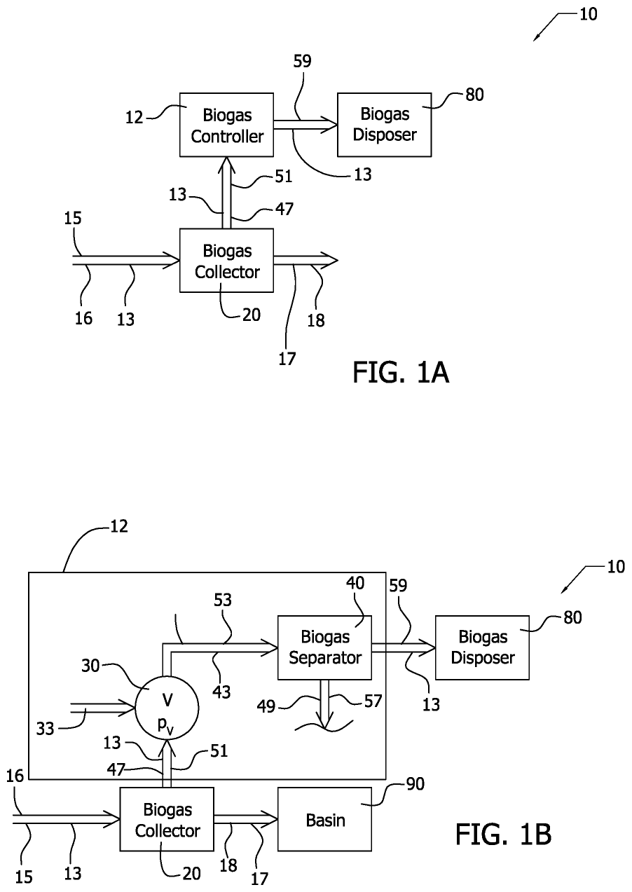

FIG. 1A illustrates exemplary biogas capture apparatus 10 including biogas collector 20, biogas controller 12, and biogas disposer 80. As illustrated in FIG. 1A, wastewater 16 is communicated into biogas collector 20 via wastewater pathway 15. Biogas 13 is released from wastewater 16 within biogas collector 20 and collected within biogas collector 20, as illustrated in FIG. 1A. Wastewater 18 having a reduced amount of biogas 13 is communicated from biogas collector 20 via wastewater pathway 17, as illustrated in FIG. 1A.

Wastewater 16, in various implementations, may be formed as wastewater, and biogas 13 may be entrained in wastewater 16, for example, by being dissolved in wastewater 16 and/or as bubbles entrained in wastewater 16. Wastewater 18 may include a reduced quantity of biogas 13 in comparison with wastewater 16, the biogas 13 having been released within biogas collector 20.

As biogas 13 collects within biogas collector 20, biogas controller 12 communicates with biogas collector 20 to control withdrawal of biogas 13 from biogas collector 20, as illustrated in FIG. 1A. Biogas 13 is communicated from biogas collector 20 to biogas disposer 80 as controlled by biogas controller 12, in this implementation. Biogas disposer then disposes of biogas 13.

FIG. 1B further illustrates exemplary biogas capture apparatus 10 that includes basin 90, biogas collector 20, biogas controller 12, biogas disposer 80, and wastewater pathways 15, 17. Biogas controller 12 includes biogas collector 20, vacuum source 30, and fluid pathways 51, 53, 57, 59, in this implementation. Fluid, as used herein, includes liquid, gas, and combinations of liquid and gas, and a fluid pathway communicates the fluid, as would be readily understood by those of ordinary skill in the art upon study of this disclosure. Wastewater pathways 15, 17 and fluid pathways 51, 53, 57, 59 may be fluid tight and collapse resistant under vacuum pressures. Wastewater pathways 15, 17 and fluid pathways 51, 53, 57, 59 may be variously formed from pipe that, for example, may be made of steel, high density polyethylene (HDPE), ductile iron, polyvinyl chloride (PVC), structures that, for example, may be made of concrete, steel, or plastic, and various combinations of pipes, structures and materials, as would be readily understood by those of ordinary skill in the art upon study of this disclosure.

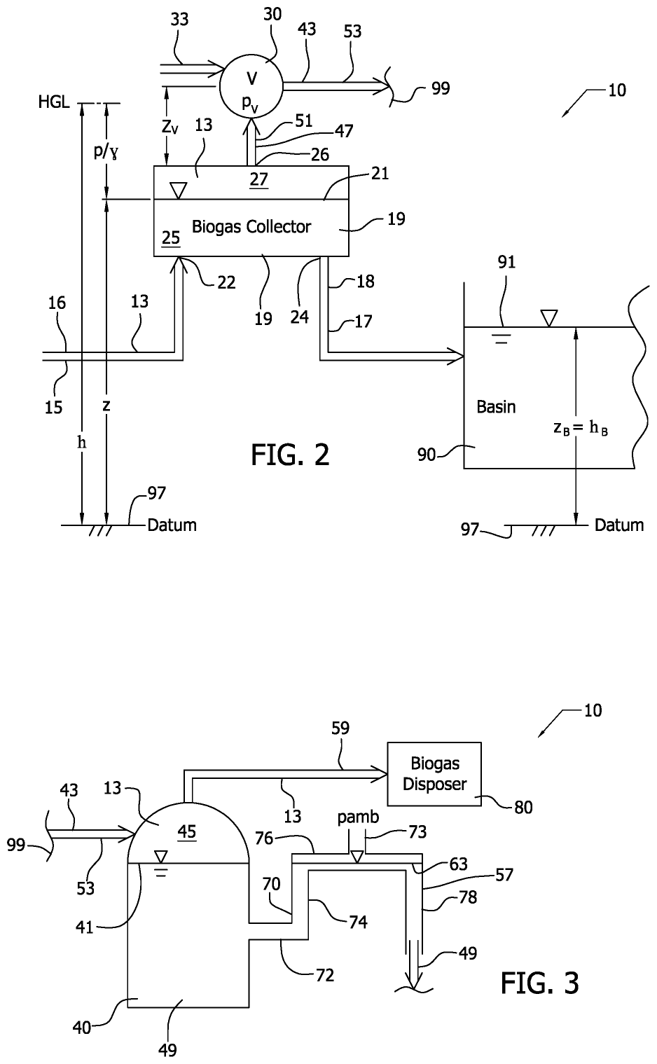

Basin 90 is illustrated in FIG. 2 as a generalized basin having a free surface 91 at ambient pressure p_{amb} for explanatory purposes, but basin 90 may be enclosed and pressurized, in various other implementations. Basin 90 may include, for example, a head-works of a wastewater treatment plant, a preliminary, primary or secondary treatment-process unit, a wastewater channel, a dewatering or thickening flocculation vessel (upstream of dewatering or thickening) or any other primary-flow-receiving channel, vessel or structure, as would be readily recognized by those of ordinary skill in the art upon study of this disclosure. In various implementations, basis 90 may include a pumping station, wet well, receiving manholes at transitions to gravity sewers, and other structures that may be open to the atmosphere inclusive of locations with odor control.

Wastewater 16 and wastewater 18 may be communicated via wastewater pathways 15, 17, respectively, under pressurized flow conditions, and the pressure of wastewater 16 and wastewater 18 while being communicated through wastewater pathways 15, 17 may be greater than ambient pressure p_{amb} except, for example, in portions of wastewater pathways 15, 17 proximate biogas collector 20 and within collector chamber 25 of biogas collector 20, as illustrated in FIG. 2. Ambient pressure p_{amb}, as used herein, refers to the actual atmospheric pressure surrounding biogas capture apparatus 10. Ambient pressure p_{amb} may vary, for example, with elevation or weather conditions. Pressure as used herein is with respect to ambient pressure p_{amb} (e.g., gauge pressure) unless otherwise noted, so that positive pressures are pressures greater than ambient pressure p_{amb} and vacuum pressures (negative pressures) are pressures less than ambient pressure p_{amb}. Pressurized flow to pressure within a wastewater pathway, such as wastewater pathways 15, 17, or within a fluid pathway, such as fluid pathway 51, 53, 57, 59, that may be at other than ambient pressure p_{amb}—either greater than ambient pressure p_{amb} (e.g., positive pressure) or less than ambient pressure p_{amb} (e.g., negative or vacuum pressure).

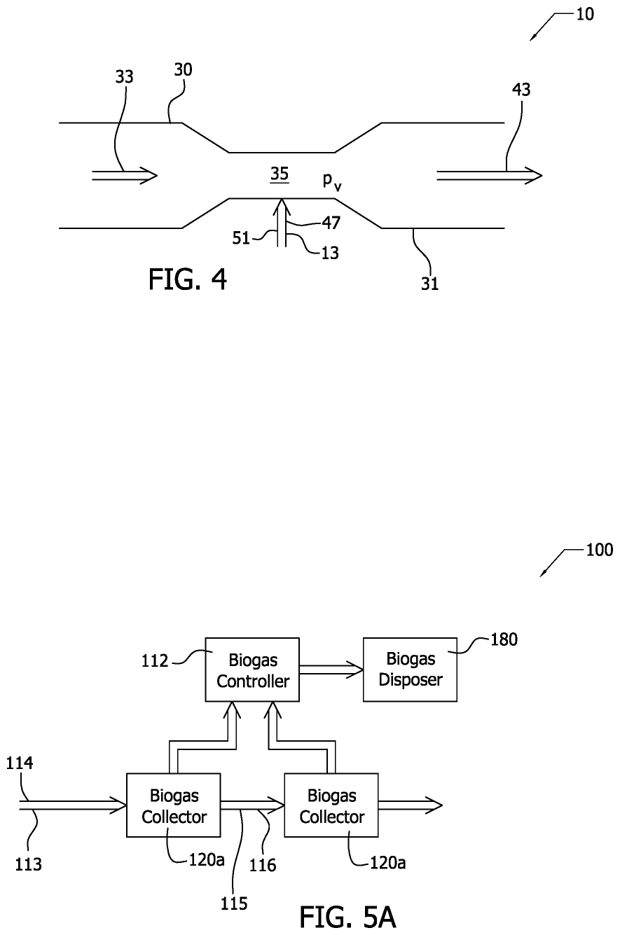

As illustrated in FIG. 1B, vacuum source 30 cooperates with biogas collector 20 to communicate biogas 13 as fluid 47 from collector chamber 25 of biogas collector 20 via fluid pathway 51. In various implementations, fluid 47, may be essentially biogas 13, may be biogas 13 with liquid films of wastewater 19 from collector chamber 25 from co-conveyance of bubbles, or may be predominantly wastewater 19 containing biogas 13. Vacuum source 30, in exemplary biogas capture apparatus 10, is formed as an eductor 31 (see FIG. 4). Eductor 31 may be formed, for example, as a Venturi, nozzle, jet pump, or vacuum ejector, in various implementations. Feedwater 33 flows through eductor 31 producing vacuum pressure pᵥ that communicates biogas 13 from biogas collector 20 to biogas separator 40 as fluid 43. Fluid 43 is formed as a mixture of biogas 13, feedwater 33, and, possibly, wastewater 19 from collector chamber 25 of biogas collector 20 (see FIG. 2), in this implementation. Fluid 43 may have various liquid water contents including no liquid water content (e.g. entirely gaseous). In various implementations, fluid 43 may comprise mostly biogas 13 with thin films of water, such as feedwater 33 and/or wastewater 19, separating bubbles of biogas 13, or may comprise mostly water, such as feedwater 33 and/or wastewater 19 with entrained biogas 13. In other implementations, vacuum source 30 may be formed as a vacuum pump or a positive-displacement pump (such as a progressive-cavity, rotary-lobe, peristaltic, piston, diaphragm, or various other pump types), which would eliminate feedwater 33 and may eliminate the need for biogas separator 40.

As illustrated in FIG. 1B and FIG. 3, biogas separator 40 communicates with vacuum source 30 via fluid pathway 53 to receive fluid 43. Biogas separator 40 separates fluid 43 into constituents of water 49 and biogas 13. Water 49 is then communicated from biogas separator 40 via fluid pathway 57 for disposal, and biogas 13 is communicated from biogas separator 40 to biogas disposer via fluid pathway 59. Biogas disposer 59 then disposes of biogas 13, for example, by treatment, combustion, absorption, or combinations thereof, in various implementations. In certain implementations wherein the biogas collector 20 and vacuum source 30 are configured to eliminate wastewater 19 and feedwater 33 from communication with biogas though fluid pathway 53, the biogas separator 40 may be omitted as unnecessary.

As illustrated in FIG. 3, fluid pathway 57 forms gooseneck 70 that includes connector 72, vertical riser 74, horizontal run 76, discharge conduit 78. Horizontal run 76 of gooseneck 70 is vented to ambient pressure p_{amb} by vent 73 in order to set pressure p=0 gauge at interface 41 between water 49 and biogas 13 within separator chamber 45 and to position interface 41 at an elevation proximate to that of free surface 63 in horizontal run 76, as illustrated in FIG. 3. Thus, the elevation of horizontal run 76 positions interface 41 within separator chamber 45.

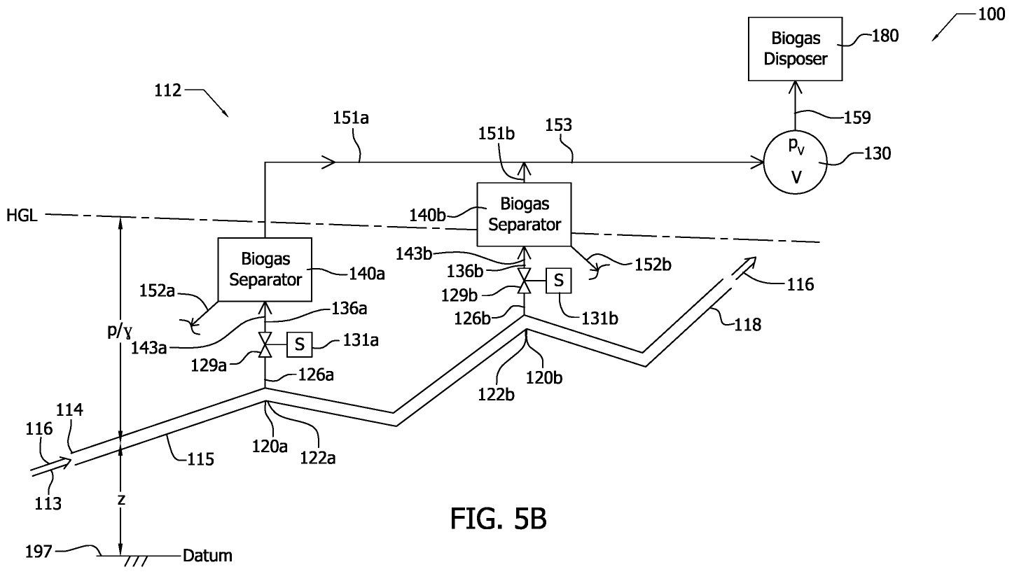

As illustrated in FIG. 2, biogas collector 20 is formed as a pressure vessel that defines collector chamber 25 enclosed within biogas collector 20. Wastewater pathways 15, 17 cooperate with biogas collector 20 to communicate wastewater 16 into collector chamber 25 of biogas collector 20 through inflow port 22 and to communicate wastewater 18 from collector chamber 25 of biogas collector 20 through outflow port 24, respectively, as illustrated. Various baffles and other turbulence-inducing devices may be included within chamber 25, in various implementations, that may facilitate release of biogas 13 from wastewater 19 within collector chamber 25. In other implementations, biogas collector 20 may be formed by elevated portions of wastewater pathways, such as elevated portions of wastewater pathways 15, 17, 115 (see FIG. 5). As illustrated, headspace 27 is formed above interface 21 of wastewater 19 within collector chamber 25, and biogas 13 released from wastewater 19 within biogas collector 20 collects within headspace 27, as illustrated.

Biogas collector 20 may release biogas 13 from wastewater 19 into headspace 27 within collector chamber 25, at least in part, according to Henry's Law. Thus, in order to facilitate release of biogas 13 from wastewater 19, collector 20 may be positioned at a location in biogas capture apparatus 10 with elevation z of interface 21 with respect to datum 97, as illustrated in FIG. 2, thereby producing hydraulic head h=p/γ+z at interface 21, where p/γ is the pressure head and γ is the specific weight of water (e.g., 62.4 lbf/ft³ or 9.81 kN/m³). Also note that pressure head p/γ at interface 21 is illustrated in FIG. 2 as positive (hydraulic head h is greater than elevation z) for purposes of explanation, while, in fact, the pressure head p/γ at interface 21 may be negative meaning the hydraulic head h at interface 21 is less than elevation z, in various implementations. Further note that, while interface 21 is illustrated as a discrete boundary with headspace 27 occupied only by gas including biogas 13 for explanatory purposes, interface 21 may be ill defined with headspace 27 occupied by a foamy mixture of wastewater 19 and biogas 13, in various implementations. Additionally, the interface 21 will likely slope downward from left to right as illustrated because the wastewater 16 may have a lower density than wastewater 18 due to the presence of biogas 13 in wastewater 16, which is removed between inflow port 22 and outflow port 24. Accordingly, wastewater 18 may have less gas-phase biogas and, thus, have a density closer to, if not equal to the specific weight of water. Because the interface 21 above the inflow port 22 and outflow port 24 may be subject to the same hydraulic head h, the fluid level above the less-dense wastewater 16 and inflow port 22 may be higher than above outflow port 24. The difference in fluid levels may be used to induce turbulence to improve biogas 13 removal from the wastewater 16.

As illustrated in FIG. 2, free surface 91 of basin 90 is at elevation z_{B} thereby having hydraulic head h_{B} equal to the elevation (i.e. h_{B}=z_{B}) with respect to datum 97. By positioning biogas collector 20 so that interface 21 is at elevation z, the pressure head p/γ=z_{B}−z+h_{L} at interface 21 within collector chamber 25 of biogas collector 20 is reduced or negative, in this implementation. Head loss h_{L} represents energy losses including friction losses and minor losses between collector 20 and basin 90. In various implementations, pressure head p/γ at interface 21 within collector chamber 25 of biogas collector 20 may range generally from about −15 ft to about −30 ft of water below ambient pressure head p_{amb}/γ. Ignoring head loss h_{L} in wastewater pathway 17 from biogas collector 20 to basin 90, pressure head p/γ at interface 21 is then generally given by the elevation difference between biogas collector 20 and free surface 91 of basin 90 so that p/γ≈−Δz=z_{B}−z. The elevation difference Δz may range generally from about 15 ft to about 30 ft, in certain implementations. That is, biogas collector 20 may be positioned about 15 ft to about 30 ft above free surface 91 of basin 90, in certain implementations, to give pressure head p/γ generally within a range of from about −15 ft to about −30 ft of water below ambient pressure head p_{amb}/γ. In various implementations, for example, the pressure at interface 21 of biogas collector 20 may be between about −0.150 bar and about −1.014 bar. In various implementations, for example, the pressure at interface 21 may be between about −0.45 bar and about −0.90 bar. In various implementations, for example, the pressure at interface 21 may be between about −0.15 bar and about −0.90 bar.

Note that pressure head p/γ within collector chamber 25 at interface 21 may vary as elevation z_{B} of free surface 91 of basin 90 varies or as wastewater 18 flow rate changes and the dynamic losses h_{L} in wastewater pathway 17 change accordingly. Wastewater pathway(s) 15, 17 may be altered when fabricating biogas capture apparatus 10 in order to position biogas collector 20 with respect to datum 97, for example, to produce pressure head p/γ at interface 21 within collector chamber 25 of biogas collector 20 generally in the range of from about −15 ft to about −30 ft of water.

Vacuum port 26, as illustrated in FIG. 2, is positioned at upper portions of biogas collector 20 to communicate with upper portions of collector chamber 25 including headspace 27. Headspace 27, as illustrated in FIG. 2, is formed as a mostly gaseous region between interface 21 and vacuum port 26. Biogas 13 released from wastewater 19 within collector chamber 25 collects to form headspace 27 within upper portions of collector chamber 25 proximate vacuum port 26, as illustrated. Wastewater 19 with biogas 13 released therefrom, at least in part, flows from collector chamber 25 into wastewater pathway 17 as wastewater 18 for delivery to basin 90.

As illustrated in FIG. 2, vacuum source 30 communicates with collector chamber 25 of biogas collector 20 through vacuum port 26 via fluid pathway 51 to apply vacuum pressure pᵥ to headspace 27 of collector chamber 25 to communicate fluid 47 including biogas 13 from headspace 27. In certain implementations, fluid 47 is either entirely or predominantly biogas 13 with trace amounts of wastewater 19. In other implementations, fluid 47 includes both biogas 13 and wastewater 19.

As illustrated in FIG. 3, biogas separator 40 is formed as a pressure vessel that defines separator chamber 45 enclosed within biogas separator 40. Biogas separator 40 communicates with vacuum port 26 of biogas collector 20 via vacuum source 30 to receive fluid 43 within separator chamber 45, as illustrated. Fluid 43 includes fluid 47, as illustrated. Note that fluid pathway 53 illustrated in FIG. 3 connects with fluid pathway 53 illustrated in FIG. 2 at common point 99. As illustrated in FIG. 3, fluid 43 separates into components biogas 13 and water 49 within separator chamber 45 with interface 41 between biogas 13 and water 49. Fluid 43 may be communicated into separator chamber 45 above interface 41 in order to induce turbulence and splashing that may enhance the separation of fluid 43 into biogas 13 and water 49. The elevation of interface 41 and pressure within the separator chamber 45 may be controlled by vent 73 in fluid pathway 57. Vent 73 is vented to the atmosphere at ambient pressure p_{amb}, as illustrated, to produce free surface 63 and, thus, to control pressure within separator chamber 45. In some implementations, for example, water 49 may be drained back to a lower-pressure section of wastewater pathway 15 approaching the biogas collector for retreatment.

Biogas disposer 80 communicates with biogas separator 40 to receive biogas 13 from biogas separator 40. Biogas disposer 80 disposes of biogas 13. Biogas disposer 80 may include treatment systems to remove biogas 13 impurities such as H₂S, water vapor, CO₂, siloxanes, particulates, and other contaminants prior to downstream treated biogas uses. Biogas disposer 80 may include, for example, a furnace, a flare stack, boiler, engine, or combined heat and power devices, that combust at least portions of biogas 13 such as CH₄. Biogas disposer 80 may include scrubbers, compressors, compressed gas storage containers, agents that chemically capture at least portions of the biogas 13, and so forth, as would be readily recognized by those of ordinary skill in the art upon study of this disclosure.

As illustrated in FIG. 4, vacuum source 30 is configured as eductor 31. In this exemplary implementation of vacuum source 30, feedwater 33 flows through eductor 31, as indicated, producing vacuum pressure pᵥ in throat 35 that communicates biogas 13 and fluid 47 from biogas collector 20 through fluid pathway 51 into eductor 31 for entrainment into feedwater 33. Fluid 43 that includes fluid 47 combined with feedwater 33 is then communicated from eductor 31 to biogas separator 40 as fluid 43 by fluid pathway 53. While eductor 31 is illustrated as a Venturi for explanatory purposes, it should be understood that eductor 31 may be formed, for example, as a nozzle, jet pump, or vacuum ejector, in various implementations.

Also, although omitted for purposes of clarity of explanation, it should be understood that biogas capture apparatus 10, in various implementations, may include, for example, various pipes, pumps, valves, fittings, blowers, compressors, electrical pathways, data communication pathways, sensors, meters, controls, Supervisory Control and Data Acquisition (SCADA) systems, and so forth, as would be readily recognized by those of ordinary skill in the art upon study of this disclosure.

In operation of biogas capture apparatus 10, wastewater 16 that includes biogas 13 is communicated into collector chamber 25 of biogas collector 20 via wastewater pathway 15, biogas 13 released from wastewater 19 within collector chamber 25 by low pressure head p/γ within collector chamber 25 collects within collector chamber 25, and wastewater 18 discharged from collector chamber 25 is communicated via wastewater pathway 17 into basin 90. Accordingly, wastewater 18 may have less biogas 13 content than wastewater 16 due to removal of biogas 13 within collector chamber 25.

Biogas 13 released from wastewater 19 within collector chamber 25 collects within collector chamber 25 forming headspace 27. Vacuum source 30 of biogas controller 12 applies vacuum pressure pᵥ at vacuum port 26 of collector chamber 25 thereby controlling the withdrawing of fluid 47 including biogas 13 from headspace 27 and communicating fluid 43 including biogas 13 into biogas separator chamber 45 of biogas separator 40 via fluid pathways 51, 53. Controller 12 may apply vacuum pressure pᵥ either intermittently or continuously, and controller 12 may alter vacuum pressure pᵥ in order to control the withdrawal of fluid 47 including biogas 13 from headspace 27. Accordingly, fluid 47 may be withdrawn either intermittently or continuously from headspace 27.

Fluid 43 is then separated into components biogas 13 and water 49 within separator chamber 45. In some implementations, fluid 43 may comprise essentially biogas 13 with little or no liquid water 49. Fluid 43 may include water vapor along with biogas 13. The water content of fluid 43 may be regulated by selecting the elevation zᵥ of vacuum source 30 above vacuum port 26 of biogas collector 20. In various implementations, a dissolved concentration of a component of the biogas in wastewater passing through the collector chamber is reduced to less than about 80% of the component saturation concentration at ambient pressure and wastewater temperature of the wastewater, the component being, for example, H₂S, or CH₄.

After being separated from fluid 43 within separator chamber 45 of biogas separator 40, biogas 13 is communicated from separator chamber 45 of biogas separator 40 to biogas disposer 80. Biogas disposer 80 then disposes of biogas 13, for example, by combustion, by capture, or combinations of combustion and capture, in various implementations.

After being separated from fluid 43 within separator chamber 45 of biogas separator 40, water 49, if any, is then communicated from separator chamber 45 of biogas separator 40 via fluid pathway 57, for example, variously to wastewater pathway 15, wastewater pathway 17, basin 90, or some other drainage-collection and disposal location(s).

FIG. 5A illustrates exemplary biogas capture apparatus 100 including biogas collectors 120a, 120b, biogas controller 112, and biogas disposer 180. As illustrated in FIG. 5A, wastewater 116 containing biogas 113 is communicated into biogas collectors 120a, 120b that are located along wastewater pathway 115. Biogas 113 released from wastewater 116 within biogas collectors 120a, 120b is collected within biogas collectors 120a, 120b, in this implementation, so that amount of biogas 113 in wastewater 116 may be diminished along wastewater pathway 115.

As biogas 113 collects within biogas collectors 120a, 120b, biogas controller 112 communicates fluidly with biogas collectors 120a, 120b to control withdrawal of biogas 113 from biogas collectors 120a, 120b, as illustrated in FIG. 5A. Biogas 113 is communicated from biogas collectors 120a, 120b to biogas disposer 180 as controlled by biogas controller 112, in this implementation. Biogas disposer 180 then disposes of biogas 113 captured from wastewater 116 as wastewater 116 is communicated along wastewater pathway 115.

As illustrated in FIG. 5B, biogas capture apparatus 100 including wastewater pathway 115, biogas collectors 120a, 120b, valves 129a, 129b, vacuum source 130, biogas separators 140a, 140b, and biogas disposer 180. Biogas controller 112, in this implementation, includes valves 129a, 129b with corresponding controllers 131a, 131b, respectively. Biogas controller 112 further includes biogas separators 140a, 140b, vacuum source 130, and at least portions of fluid pathways 126a, 126b, 136a, 136b, 151a, 151b, 153, in this illustrated implementation.

As illustrated in FIG. 5B, wastewater pathway 115 is a force-main (e.g. pressurized fluid conveyance) that conveys wastewater 116 in the form of wastewater that contains biogas 113 from end 114 to end 118. Wastewater pathway 115 may extend beyond ends 114, 118, which are denoted for explanatory purposes, and wastewater pathway 115 may include, for example, branches, sections of differing sizes, parallel sections, in various implementations. In various other implementations, biogas collectors, such as biogas collectors 120a, 120b, may be positioned at various locations having pressurized flow conditions.

Biogas 113 may be produced, at least in part, by biological activity within wastewater 116 as wastewater 116 is conveyed via wastewater pathway 115. The hydraulic grade line (HGL), which is the slope of the hydraulic head h=p/γ+z, is included in FIG. 5B in relation to wastewater pathway 115, and the HGL decreases in the direction of flow. Note that the hydraulic head h at a location along wastewater pathway 115 is equal to the elevation z of wastewater pathway 115 with respect to datum 197 at the location plus the pressure head p/γ, where p is the pressure within wastewater pathway 115 at the location. Thus, in exemplary biogas capture apparatus 100, biogas collectors 120a, 120b are formed by highpoints 122a, 122b of wastewater pathway 115 that approach the HGL and, thus, pressure heads p/γ at highpoints 122a, 122b are correspondingly lower than adjacent segments of wastewater pathway 115.

Biogas 113 may be released, in part, from wastewater 116 proximate biogas collectors 120a, 120b due to the lowered pressure heads p/γ at highpoints 122a, 122b that are not sufficient to maintain biogas 113 in a dissolved state in wastewater 116. Biogas 113, including other gasses released due to lowered pressure head p/γ, may collect at biogas collectors 120a, 120b by virtue of the location of biogas collectors 120a, 120b at highpoints 122a, 122b-biogas 113 released from solution, which is buoyant, tends to collect at highpoints 122a, 122b.

As illustrated in FIG. 5B, biogas collectors 120a, 120b communicate with valves 129a, 129b that, in turn, communicate with biogas separators 140a, 140b, respectively. Biogas separators 140a, 140b communicate with vacuum source 130, in part, via fluid pathways 151a, 151b, respectively, that merge into fluid pathway 153, as illustrated. Vacuum source 130, in turn, communicates with biogas disposer 180 via fluid pathway 159, as illustrated. Vacuum source 130 generates vacuum pressure pᵥ that is then communicated with biogas separators 140a, 140b via fluid pathways 151a, 151b, 153, as illustrated.

Valves 129a, 129b are located at biogas collectors 120a, 120b, as illustrated in FIG. 5B. Valves, such as valves 129a, 129b may be, for example, air release valves that release air including other gasses from wastewater pathway 115 or vacuum release valves that allow air to enter wastewater pathway 115 in order to relieve negative transient pressures within wastewater pathway 115. In certain implementations, vacuum release or other features to control negative transient pressures may be provided separately from features provided by the elements of biogas capture apparatus 100 and are not specifically addressed by this invention. Valves 129a, 129b may include mechanical or electric-powered high-level-actuated valves that fulfill the opening/closing valve-control function in various applications. In certain implementations, valves, such as valves 129a, 129b, may be new, replacement, or another valve or valve type suitable for operation at, for example, highpoints 122a, 122b, respectively. Thus, valves, such as valves 129a, 129b, may be located at highpoints 122a, 122b of wastewater pathway 115 as part of a pre-existing configuration of wastewater pathway 115, which may facilitate retrofitting of vacuum source 130 with valves, such as valves 129a, 129b, in order to form biogas capture apparatus 100.

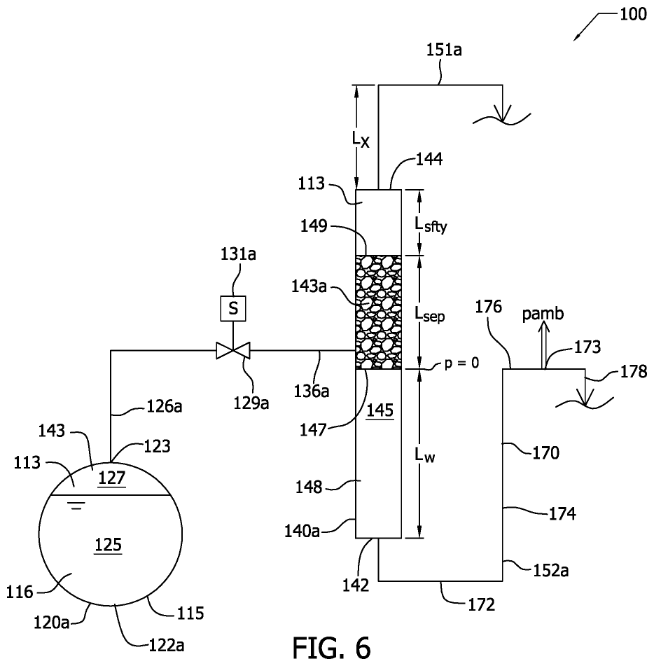

As illustrated in FIG. 6, biogas collector 120a including collector chamber 125 is formed as a portion of wastewater pathway 115 proximate highpoint 122a that is circular in shape with crown 123. Although wastewater pathway 115 is illustrated in FIG. 6 as circular for explanatory purposes, wastewater pathway 115 may assume various other geometric shapes and the size and shape of wastewater pathway 115 may vary in size or shape along its length, in various implementations. Note that biogas collector 120b at highpoint 122b, valve 129b, fluid pathways 126b, 136b, and biogas separator 140b are configured similarly to biogas collector 120a, valve 129a, fluid pathways 126a, 136a, and biogas separator 140a illustrated in FIG. 6, in this implementation.

As illustrated in FIG. 6, headspace 127 containing biogas 113 released from water is formed in portions of collector chamber 125 proximate crown 123 at highpoint 122a. FIG. 6 illustrates valve 129a that communicates with collector chamber 125 proximate crown 123 to control the communication of biogas 113 from headspace 127 to biogas separator 140a via fluid pathways 126a, 136a. Biogas separator 140a may be retrofit to an existing valve 129a by attachment of fluid pathway 136a to an existing valve 129a.

Valves 129a, 129b of controller 112 may be actuated by valve controllers 131a, 131b, respectively, between an OPEN position, a CLOSED position, and positions intermediate of the OPEN position and the CLOSED position to control the communication of biogas 113 from a headspace, such as headspace 127, to biogas separators 140a, 140b. Valve controllers, such as valve controllers 131a, 131b, includes, for example, a solenoid, a drive motor, a hydraulic, pneumatic, or electric actuator, in various implementations.

As illustrated in FIG. 6, exemplary biogas separator 140a is formed as a vertical cylinder with bottom 142 and top 144 and defining separator chamber 145. Fluid pathway 136a communicates with separator chamber 145 between bottom 142 and top 144, as illustrated, to communicate fluid 143a into separator chamber 145 from headspace 127. Fluid 143a includes biogas 113, and fluid 143a may include various quantities of water 148 thus forming a foamy or bubbly mixture. In some implementations, fluid 143a is generally devoid of water 148 so that fluid 143a includes essentially gas, for example, biogas 113 along with water vapor and, possibly, air. Water 148 may include wastewater 116 from biogas collector 120a, water condensed from water vapor, and water from other sources, such as a vacuum source, for example vacuum source 30, 130.

Fluid pathway 151a communicates with separator chamber 145 at top 144 to communicate biogas 113 from separator chamber 145 to vacuum source 130 and, thence, to biogas disposer 180, as illustrated. Drain 152a communicates with separator chamber at bottom 142, as illustrated, to drain water 148 from separator chamber 145 for disposal.

Water 148 separated from fluid 143a fills a portion of separator chamber 145 between bottom 142 and interface 147, as illustrated in FIG. 6. Drain 152a that fluidly communicates with separator chamber 145 forms gooseneck 170 that includes connector 172, vertical riser 174, horizontal run 176, discharge conduit 178. Horizontal run 176 of gooseneck 170 is vented to ambient pressure p_{amb} by vent 173 in order to set pressure p=0 gauge at interface 147 between water 148 and fluid 143a within separator chamber 145 and to position interface 147 at an elevation proximate to that of horizontal run 176, as illustrated in FIG. 6. Thus, the elevation of horizontal run 176 sets height L_{w} of interface 147 above bottom 142 within separator chamber 145 as adjusted for dynamic losses in connector 172 and vertical riser 174 of gooseneck 170, as illustrated. In various implementations, additional capacity for water 148 may be included within vertical riser 174 to prevent extreme vacuum pressures in separator chamber 145 from draining gooseneck 170.

As illustrated in FIG. 6, fluid 143a, which is illustrated as a bubbly mixture of biogas 113 and water 148, fills a portion of the separator chamber 145 between interface 147 and interface 149, with pressure decreasing, for example, to between about −5 ft to about −30 ft of water at interface 149 due to vacuum pressure pᵥ of vacuum source 130. The portion of the separator chamber 145 between interface 147 and interface 149 has a height of Lₛₑₚ, as illustrated, and represents a region within which fluid 143a separates into biogas 113 and water 148. In various implementations, the ability to store an adequate volume of water 148 in vertical riser 174 may be provided to prevent gooseneck 170 from being drained as pressure in headspace 113 becomes increasingly negative. In other implementations, measures or controls may be provided to positively supply water 148 or water from another source to prevent gooseneck 170 from being drained.

Biogas 113, which has been separated from fluid 143a, fills a portion of the separator chamber 145 between interface 149 and top 144, as illustrated in FIG. 6, and biogas 113 is removed from the portion of separator chamber 145 between interface 149 and top 144 via fluid pathway 151a by vacuum source 130. Note that water vapor, air, and other gasses may also be included along with biogas 113 in the portion of the separator chamber above interface 149. The portion of the separator chamber between interface 149 and top 144 has length L_{sfty}, as illustrated, and fluid pathway 151a is elevated above top 144 by length Lₓ. Lengths L_{sfty} and Lₓ may be selected to prevent communication of water 148 to fluid pathway 151a, 153 or to vacuum source 130 from separator chamber 145.

Various implementations of a biogas capture apparatus, such as biogas capture apparatus 100, may include any number of biogas collectors, such as biogas collectors 120a, 120b, and valves, such as valves 129a, 129b, located at any number of highpoints, such as highpoints 122a, 122b. Various numbers and configurations of biogas separator(s), such as biogas separators 140a, 140b, vacuum source(s), such as vacuum source 130, and biogas disposer(s), such as biogas disposer 180, may be included in various implementations. Various numbers of biogas controllers, such as biogas controller 112, and various numbers of biogas disposers, such as biogas disposer 180, may be included in various implementations. Although omitted for purposes of clarity of explanation, various implementations of a biogas capture apparatus, such as biogas capture apparatus 100, may include, for example, various pipes, pumps, channels, basins, sumps, reservoirs, valves, fittings, compressors, electrical pathways, data communication pathways, sensors, meters, controls, SCADA systems, and so forth, as would be readily recognized by those of ordinary skill in the art upon study of this disclosure. For example, a SCADA system may communicate with valve controllers 131a, 131b to allow for remote actuation of valves 129a, 129b, respectively.

In operation of biogas capture apparatus 100, wastewater 116 that includes biogas 113 flows from end 114 to end 118 of wastewater pathway 115, and biogas 113 released from wastewater 116 during passage through wastewater pathway 115 collects at biogas collectors 120a, 120b located at highpoints 122a, 122b, respectively. Valves 129a, 129b in combination with vacuum source 130 of biogas controller 112 control the communication of biogas 113 from biogas collectors 120a, 120b to biogas disposer 180, in this implementation. Valves 129a, 129b may be actuated to control the withdrawal of biogas 113 from biogas collectors 120a, 120b. Valves 129a, 129b may be opened intermittently to intermittently withdraw biogas 113 from biogas collectors 120a, 120b and closed to allow biogas 113 to collect within biogas collectors 120a, 120b. For example, when sufficient biogas 113 has collected at biogas collectors 120a, 120b, valves 129a, 129b at biogas collectors 120a, 120b, respectively, are actuated into the OPEN position thereby allowing fluid communication of biogas 113 from biogas collectors 120a, 120b to biogas separators 140a, 140b, respectively, and, thence, to vacuum source 130, and, finally, to biogas disposer 180. With valves 129a, 129b opened, biogas 113 that has collected, for example, proximate crown 123 of wastewater pathway 115 at biogas collector 120a, is then communicated as fluid 143a from biogas collector 120a to biogas separator 140a through valve 129a via fluid pathways 126a, 136a. Similarly, biogas 113 is communicated as at least a part of fluid 143b from biogas collector 120b to biogas separator 140b through valve 129b via fluid pathways 126b, 136b, as illustrated in FIG. 5B. Note that fluids 143a, 143b may have varying liquid water contents, in various implementations, including essentially no liquid water content, and fluids 143a, 143b may differ from one another. Following withdrawal of biogas 113 from biogas collectors 120a, 120b, valves 129a, 129b may be actuated into the CLOSED position.

Fluids 143a, 143b are communicated, at least in part, from biogas collectors 120a, 120b to biogas separators 140a, 140b using available positive hydraulic pressures at highpoints 122a, 122b, respectively, as indicated by the hydraulic grade line above biogas collectors 120a, 12b at highpoints 122a, 122b, respectively, as illustrated in FIG. 5B. In certain implementations, vacuum pressure pᵥ of vacuum source 130 may communicate with biogas collectors 120a, 120b to communicate fluids 143a, 143b from biogas collectors 120a, 120b to biogas separators 140a, 140b, respectively. In certain implementations, positive hydraulic pressures at highpoints 122a, 122b in combination with vacuum pressure pᵥ of vacuum source 130 may communicate fluids 143a, 143b from biogas collectors 120a, 120b to biogas separators 140a, 140b, respectively.

As illustrated in FIG. 5B, vacuum pressure pᵥ of vacuum source 130 enables collection of biogas 113 from biogas separators 140a, 140b over distances that may range, for example, from several hundred feet to one or more miles. Vents, such as vent 173, at biogas separators 140a, 140b create an atmospheric break between vacuum pressure pᵥ of vacuum source 130 and biogas collectors 120a, 120b, in exemplary biogas capture apparatus 100.

Valves 129a, 129b may then be closed when the withdrawal of biogas 113 from biogas collectors 120a, 120b, respectively, is complete. Valves 129a, 129b may be actuated between OPEN and CLOSED as needed using valve controllers 131a, 131b to control the withdrawal of biogas 113 from biogas collectors 120a, 120b, respectively. Valves 129a, 129b may be actuated simultaneously or in various sequences with respect to one another, in various implementations. I

Fluid 143a, 143b is separated into biogas 113 and water 148 within biogas separators 140a, 140b, respectively. Following separation of fluid 143a, 143b into water, such as water 148, and biogas 113 at biogas separators 140a, 140b, biogas 113 is communicated from biogas separators 140a, 140b, to vacuum source 130 by vacuum pressure pᵥ of vacuum source 130 and thence to biogas disposer 180 via fluid pathways 151a, 151b, 153, 159, as illustrated. Vacuum pressure pᵥ of vacuum source 130 may be applied either intermittently or continuously and vacuum pressure pᵥ may be altered in order to control the withdrawal of biogas 113 from biogas separators 140a, 140b.

Biogas 113 is then disposed of by biogas disposer 180, for example, by combustion, collection, further treatment, or combinations thereof. Biogas disposer may beneficially use biogas 113 as a renewable energy source. Collection may include, for example, capture of one or more components of biogas 113 as a compressed gas in a compressed gas cylinder, and collection may include chemical absorption or adsorption of one or more components of biogas 113. Combustion may include, for example, combusting of one or more components of biogas 113 with oxygen, for example, by combustion of CH₄ by flaring, combusting CH₄ to fire a furnace, or combusting CH₄ as engine fuel. Combustion may include reacting one or more components of biogas 113 to chemically alter one or more biogas components, for example, oxidizing H₂S to produce sulfate SO₄⁻². Further treatment may include adsorption or absorption of undesirable components onto or into designed media, in combination with or independent of use of multiple other various biogas treatment methods. Water, such as water 148, separated from fluid 143a, 143b within biogas separators 140a, 140b is communicated from biogas separators 140a, 140b by drains 152a, 152b, respectively, for disposal.

In operation of a biogas capture apparatus, such as biogas capture apparatus 10, 100, a biogas collector, such as biogas collector 20, 120a, 120b, receives wastewater, such as wastewater 16, 116, containing biogas, such as biogas 13, 113. Biogas, such as biogas 13, 113, from the wastewater, is released within a collector chamber, such as collector chamber 25, 125, of the biogas collector. As biogas collects within the collector chamber, a biogas controller, such as biogas controller 12, 112, then controls the withdrawal of biogas from the collector chamber and the communication of the biogas from the biogas collector to a biogas disposer, such as biogas disposer 80, 180 for disposal. Withdrawal of biogas from the collector chamber as controlled by the controller may be either continuous or intermittent, in various implementations. The biogas controller may include a vacuum source, such as vacuum source 30, 130. In certain implementations, the vacuum source withdraws the biogas from the collector chamber of the biogas collector. Certain implementations include a biogas separator that separates biogas from water following withdrawal of the biogas from the collector chamber. In such implementations, the vacuum source may withdraw biogas from the biogas separator following separation of biogas from water. Thus, the biogas capture apparatus captures biogas from wastewater and disposed of the biogas.

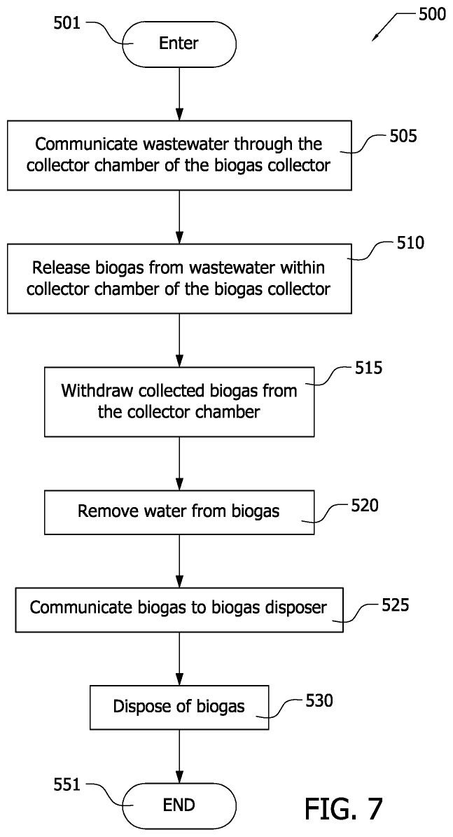

Exemplary method of operation 500 of the biogas capture apparatus that captures biogas from water and disposes of the biogas is illustrated in FIG. 7. As illustrated in FIG. 7, method of operation 500 is entered as step 501.

At step 505, wastewater is communicated through the collector chamber of the biogas collector.

Biogas is released from wastewater within the collector chamber of the biogas collector, at step 510.

At step 515, collected biogas is withdrawn in a controlled manner from the collector chamber thereby capturing the biogas from the water. Withdrawal of biogas from the collector chamber may be either continuous or intermittent, in various implementations.

At step 520, any water that is included with the biogas following withdrawal of the biogas from the collector chamber is removed from the biogas.

At step 525, the biogas is communicated to the biogas disposer.

At step 530, the biogas is disposed of by the biogas disposer.

Method of operation 500 terminates at step 551.

The foregoing discussion along with the Figures discloses and describes various exemplary implementations. These implementations are not meant to limit the scope of coverage, but instead, to assist in understanding the context of the language used in this specification and in the claims. The Abstract is presented to meet requirements of 37 C.F.R. § 1.72(b) only. Accordingly, the Abstract is not intended to identify key elements of the methods and apparatus disclosed herein or to delineate the scope thereof. Upon study of this disclosure and the exemplary implementations herein, one of ordinary skill in the art may readily recognize that various changes, modifications and variations can be made thereto without departing from the spirit and scope of the inventions as defined in the following claims.

The invention claimed is:

1. A method for capturing biogas, comprising the steps of:
collecting biogas within a collector chamber of a biogas collector formed at an elevated location in a wastewater system, the biogas being released from wastewater passing through the collector chamber;
controlling the withdrawing of biogas from the collector chamber; and
capturing the biogas withdrawn from the collector chamber.

2. The method of claim 1, further comprising the step of:
performing the step of collecting biogas within a collector chamber of a biogas collector by reducing a pressure within at least portions of the collector chamber.

3. The method of claim 2, wherein the pressure is between about negative 0.15 bar gauge pressure and about negative 1.014 bar gauge pressure.

4. The method of claim 1, further comprising the step of:
conveying biogas withdrawn from the collector chamber to a biogas disposer.

5. The method of claim 1, further comprising the step of:
communicating biogas through at least portions of a biogas controller using a vacuum source, the biogas controller performing the step of controlling the withdrawing of biogas from the collector chamber, and the biogas controller comprising the vacuum source.

6. The method of claim 1, further comprising the step of:
separating biogas from water within a separator chamber of a biogas separator, the separator chamber receiving water combined with biogas withdrawn from the collector chamber.

7. The method of claim 6, further comprising the step of:
withdrawing biogas from the separator chamber using a vacuum source.

8. The method of claim 1, further comprising the step of:
withdrawing biogas from the collector chamber using a vacuum source.

9. The method of claim 1, further comprising the step of:
actuating a valve using a valve controller thereby controlling at least in part the withdrawing of biogas from the collector chamber.

10. The method of claim 1, wherein a dissolved concentration of a component of the biogas in the wastewater passing through the collector chamber is reduced to less than about 80% of the component saturation concentration at ambient pressure and at a wastewater temperature of the wastewater, the component selected from a group consisting of H₂S, and CH₄.

11. A method for capturing biogas from a wastewater system, comprising the steps of:
releasing biogas from water passing through a collector chamber of a biogas collector;
communicating water combined with biogas into a separator chamber of a biogas separator, the biogas being withdrawn from the collector chamber;
separating the water combined with biogas into biogas and water within the separator chamber; and
capturing the biogas separated from the water.

12. A biogas capture apparatus, comprising:
a biogas collector formed at an elevated location in a wastewater system, the biogas collector defining a collector chamber that collects biogas released from wastewater passing through the collector chamber; and
a biogas controller that cooperates with the biogas collector to control withdrawal of biogas from the biogas collector.

13. The apparatus of claim 12, further comprising:
a vacuum source included as a portion of the biogas controller to communicate biogas through at least portions of the biogas controller.

14. The apparatus of claim 13, wherein the vacuum source reduces the pressure within at least portions of the collector chamber to between about negative 0.15 bar gauge pressure and about negative 1.014 bar gauge pressure to release biogas from the wastewater.

15. The apparatus of claim 12, wherein the vacuum source comprises an eductor.

16. The apparatus of claim 12, further comprising:
a biogas separator included as a portion of the biogas controller, the biogas separator defines a separator chamber in communication with the collector chamber to receive a mixture of water combined with biogas withdrawn from the collector chamber; and
wherein the mixture is separated into biogas and water within the separator chamber.

17. The apparatus of claim 16, further comprising:
a vacuum source included as a portion of the biogas controller, the vacuum source in fluid communication with the collector chamber and with the separator chamber to withdraw biogas from the collector chamber into the separator chamber.

18. The apparatus of claim 16, further comprising:
a vacuum source included as a portion of the biogas controller, the vacuum source in fluid communication with the separator chamber to withdraw biogas from the separator chamber.

19. The apparatus of claim 12, further comprising:
a valve actuated by a valve controller included as a portion of the biogas controller to control withdrawal of biogas from the collector chamber.

20. The apparatus of claim 12, further comprising:
a biogas disposer in fluid communication with the collector chamber to dispose of biogas withdrawn from the collector chamber.
